(19) United States
(12) Patent Application Publication
(10) Pub. No.: US 2010/0278621 A1
(43) Pub. Date: Nov. 4, 2010

(54) Bulk Material Container and Container Discharging Apparatus

(76) Inventor: Johan Redekop, Winkler (CA)

Correspondence Address: ADE & COMPANY INC., 2157 Henderson Highway, WINNIPEG, MB, R2G1P9, CA

(21) Appl. No.: 12/770,854

(22) Filed: Apr. 30, 2010

Related U.S. Application Data
(60) Provisional application No. 61/174,078, filed on Apr. 30, 2009.

(51) Int. Cl. B60P 1/42; B60P 3/00; B60P 1/00; B65G 65/46; B65G 67/24; B65D 43/14

(52) U.S. Cl. 414/523; 410/68; 220/810

(57) ABSTRACT

A bulk material container suitable for handling with a pallet mover includes a hopper portion which tapers downwardly to a discharge gate which is in an upright orientation offset to one side of the container. When several containers are supported on a flat deck vehicle or trailer, the gates of all of the containers can be oriented to discharge to the sides of the deck. A discharge apparatus supported on the deck comprises a track supporting a discharge conveyor for displacement along the sides of the deck such that an inlet hopper of the conveyor can be aligned with respective ones of the side discharging gates of the containers supported on the deck.

This application claims the benefit under 35 U.S.C. 119(e) of U.S. provisional application Ser. No. 61/174078, filed Apr. 30, 2009.

### FIELD OF THE INVENTION

The present invention relates to a bulk material container for transporting particulate material therein of the type arranged to be supported on a flat deck of a road transport vehicle, and more particularly the present invention relates to a discharging apparatus arranged for use with a road transport vehicle comprising a flat deck supporting a plurality of the bulk material containers thereon for unloading particulate material from the containers on the vehicle.

### BACKGROUND

Use of bulk seed containers are known for transporting prescribed amounts of seed or other particulate material in a palette form. A typical container has a square base in the order of four feet by four feet so that two rows of containers can be supported alongside one another on an eight foot wide flat deck of a truck or trailer for example. A typical construction of a bulk seed container comprises an upper container body which communicates with a hopper portion adjacent the bottom end thereof which tapers downwardly and inwardly to a central discharge opening lying in a generally horizontal plane. Unloading of the containers while supported on a transport vehicle thus requires a custom configuration of transport vehicle which is arranged to centrally collect all of the material from the various containers supported thereon to a central common hopper of the vehicle. Various examples of such custom vehicles are described in U.S. Pat. Nos. 6,964,551 by Freisen, 6,971,324 by Beck, 6,092,974 by Roth and 5,785,481 by Ockels. In each instance the unique configuration of the trailer require costly complex construction and results in a trailer having a limited use and a limited capacity due to the costly manufacturing thereof. Furthermore the configuration of a common central hopper discharge for unloading all the containers has potential to result in cross-contamination of different materials from the different containers so that the identity of the different seeds cannot be preserved when unloading.

U.S. Pat. No. 6,425,725 by Ehlers discloses a bulk handling apparatus in which an attachment to the flat deck of a truck permits discharging of a plurality of bulk seed containers while they remain supported on the flat bed. The attachment results in using the flat bed to function effectively as a common central hopper discharge which gathers the collected material from the containers towards the rear end of the vehicle only by tilting the deck upwardly at the front end thereof. The requirement of the tilt deck and the resulting central common discharge of all of the containers results in a transport vehicle which again has limited capacity and which results in cross-contamination of the material from the different containers even where the identity of the material in the different containers is to be preserved.

### SUMMARY OF THE INVENTION

According to one aspect of the invention there is provided a bulk material container for transporting particulate material therein, the container comprising:

a base arranged to be supported on a generally horizontal supporting surface;

a hopper portion supported on the base, the hopper portion tapering downwardly and inwardly from a perimeter about a top end of the hopper portion to a gate opening adjacent a bottom end of the hopper portion;

a plurality of side walls extending upwardly from the top end of the hopper portion fully about the perimeter of the hopper portion;

a top wall spanning between the side walls adjacent a top end of the side walls; and

a gate supported for movement between a closed position spanning the gate opening and an open position in which the gate opening is at least partially unobstructed by the gate;

wherein the gate opening is offset towards one side of the base so as to be nearer to one of the side walls.

By providing bulk material containers in which the gate openings are offset to one side of the base nearer to one of the side walls of the container than the remaining side walls, the containers can be supported on a conventional flat deck of a truck or trailer with each of the containers being suited to be independently discharged to a respective side of the vehicle without necessitating any cross-contamination with particulate material from other containers. Accordingly no costly custom trailer of limited use is required for discharging a plurality of bulk seed containers directly from a transport vehicle. Furthermore no costly attachments are required which necessitate a central common discharge of all of the bulk material containers.

The gate opening is preferably located substantially in vertical alignment below one of the side walls so as to be oriented in an upright plane.

When the base is rectangular comprising four sides, the gate opening is preferably located adjacent one of the sides of the base.

The gate is preferably slidable in an upright orientation between the closed position and the open position.

The plurality of side walls of the container may comprise a front wall at a front side of the container, a rear wall opposite the front wall at a rear side of the container and a pair of intermediate walls spanning between the front wall and the rear wall at opposing sides. In this instance, the gate opening is preferably located in the front side of the container such that the hopper portion tapers downwardly and forwardly towards the gate opening at the front side.

The hopper portion may comprise a bottom portion tapering downwardly and forwardly from the rear side of the container to the gate opening at the front side of the container. The hopper portion may further comprise a front portion extending downwardly from the front wall and locating the gate opening therein.

When provided in combination with a road transport vehicle comprising a flat deck having side edges extending in a longitudinal working direction of rolling movement of the vehicle and a plurality of other bulk material containers of like configuration supported on the flat deck, preferably the gate openings are offset towards a first side of the respective containers and the bulk material containers are supported adjacent to one another in pairs such that the first sides of each pair of containers are situated at respective ones of the side edges of the flat deck.

When the road transport vehicle comprises a flat deck having side edges extending in a longitudinal working direction of rolling movement of the vehicle and supporting the plurality of bulk material containers thereon such that the gate openings are arranged to discharge bulk material towards the sides edges of the flat deck, there may be provided a discharge apparatus comprising:

a discharge conveyor arranged to convey bulk material from an inlet end to an outlet end thereof;

a track arranged to support the discharge conveyor on the vehicle for sliding movement relative to the vehicle in the longitudinal working direction of the vehicle; and

an inlet hopper supported on the discharge conveyor in communication with the inlet end of the discharge conveyor and including an open top end arranged to receive bulk material from the bulk material containers therein;

the inlet hopper being slidable together with the discharge conveyor along the track such that the inlet hopper is arranged to be aligned with different ones of the bulk material containers as the discharge conveyor is displaced in the longitudinal working direction of the vehicle.

The discharge apparatus may further comprise a carriage comprising rollers supported for rolling movement along the track wherein the discharge conveyor and the inlet hopper are supported on the carriage so as to extend upwardly and outwardly away from the track from the inlet end to the outlet end of the discharge conveyor.

The discharge apparatus may further comprise:

a carriage comprising rollers supported for rolling movement along the track, the carriage supporting the discharge conveyor and the inlet hopper thereon for movement along the track;

a drive motor supported on the carriage; and

a drive wheel rotatably supported on the carriage so as to be arranged to engage the track, the drive wheel being driven to rotate by the drive motor so as to be arranged to displace the carriage along the track.

The track preferably comprises a pair of rails extending parallel and spaced apart one above the other to extend in the longitudinal working direction in which the carriage supporting the discharge conveyor and the inlet hopper thereon is supported for movement along the pair of rails. One of the rails may be arranged to be supported substantially at a height of a surface of the deck, spaced outwardly from the side edge of the deck and the other one of the rails may be arranged to be supported below the deck.

A plurality of track mounts are preferably arranged to support the track on the deck such that the track is readily separable from the deck of the vehicle.

The track may comprise a pair of primary sections arranged to be supported along the side edges of the deck and a secondary section connected between the pair of primary sections at one end of the deck such that a single discharge conveyor is movable along the track from one primary section on one side of the deck to the other primary section on the other side of the deck across the secondary section of the track.

The discharge conveyor may comprise an inner section and an outer section which are pivotal relative to one another between a working position in which the inner and outer sections are connected in series which one another and a transport position in which the outer section is folded relative to the inner section.

The track is preferably assembled from modular sections in which each modular section spanning a length corresponding to a dimension of a plurality of bulk material containers in series with one another in the longitudinal working direction of the vehicle.

According to a second aspect of the present invention there is provided a discharging apparatus arranged for use with a road transport vehicle comprising a flat deck having side edges extending in a longitudinal working direction of rolling movement of the vehicle and a plurality of bulk material containers having respective hopper portions tapering downwardly and inwardly to respective gate openings and being supported on the flat deck such that the gate openings are arranged to discharge bulk material towards the sides edges of the flat deck, the discharge apparatus comprising:

a discharge conveyor arranged to convey bulk material from an inlet end to an outlet end thereof;

a track arranged to support the discharge conveyor on the vehicle for sliding movement relative to the vehicle in the longitudinal working direction of the vehicle; and

an inlet hopper supported on the discharge conveyor in communication with the inlet end of the discharge conveyor and including an open top end arranged to receive bulk material from the bulk material containers therein;

the inlet hopper being slidable together with the discharge conveyor along the track such that the inlet hopper is arranged to be aligned with different ones of the bulk material containers as the discharge conveyor is displaced in the longitudinal working direction of the vehicle.

By further providing a discharge conveyor supported for movement along a track to be aligned with different ones of the bulk material containers, the conveyor can directly convey material discharged by a selected one of the containers which preserves the identity of the material being discharged. Furthermore the discharge apparatus is relatively simple and of low cost to implement as compared to prior art configurations of road vehicles adapted for discharging a plurality of bulk material containers. By supporting a track alongside the deck, the discharge apparatus does not interfere with normal operation of the deck when no bulk material containers are supported thereon so that the road vehicle can still be used for many other uses in addition to transporting and discharging bulk seed containers thereon.

One embodiment of the invention will now be described in conjunction with the accompanying drawings in which:

### BRIEF DESCRIPTION OF THE DRAWINGS

FIG. 1 is a side elevational view of a plurality of the bulk material containers supported on a road transport vehicle upon which the discharging apparatus is supported.

FIG. 2 is a top plan view of the containers and discharging apparatus according to FIG. 1.

FIG. 3 is a perspective view of one modular section of the discharging apparatus in combination with a pair of bulk material containers.

FIG. 4 is a front elevational view of the modular section of the discharging apparatus and bulk material containers of FIG. 3.

FIG. 5 is a top plan view of the modular section of the discharging apparatus and bulk material containers of FIG. 3.

FIG. 6 is an end elevational view of the modular section of the discharging apparatus and bulk material containers of FIG. 3.

FIG. 7 is an enlarged end elevational view of a portion of the discharging apparatus.

FIG. 8 is a perspective view of a second modular section of the discharging apparatus for use at a corner of the deck of the road transport vehicle in combination with a pair of bulk material containers.

FIG. 9 is a perspective view of one of the bulk material containers shown separated from the discharging apparatus.

FIG. 10 is a perspective view of the container body shown separated from the base of the bulk material container.

FIG. 11 is a front elevational view of the container body of FIG. 10.

FIG. 12 is a side elevational view of the container body of FIG. 10.

FIG. 13 is a front perspective view of the base of the bulk material container with the container body shown removed.

FIG. 14 is a rear perspective view of the base of the bulk material container with the container body shown removed.

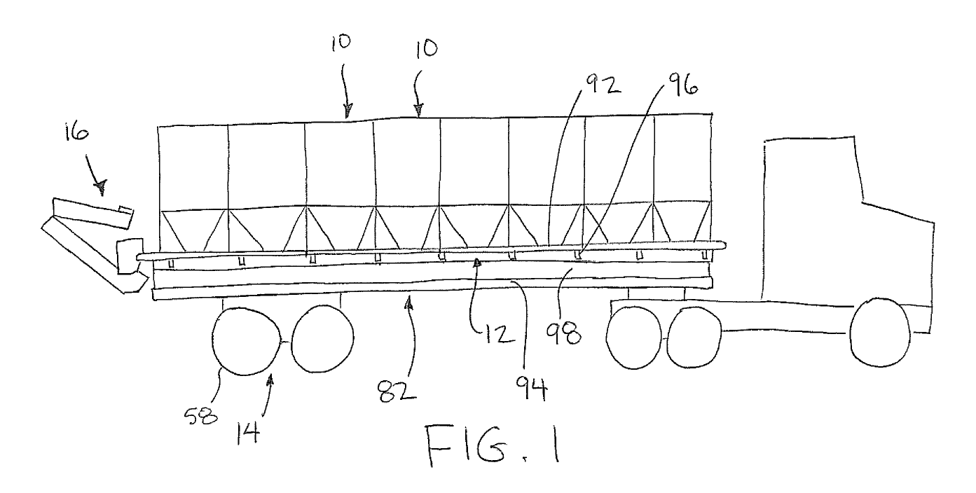

In the drawings like characters of reference indicate corresponding parts in the different figures.

### DETAILED DESCRIPTION

Referring to the accompanying figures there is illustrated a bulk material container generally indicated by reference numeral 10. The container 10 typically contains seed or other bulk particulate material in which the container is suitably sized for handling by palette moving equipment. The container 10 is also suited for being supported on the flat deck 12 of a road transport vehicle 14 for example a truck or flat deck trailer as illustrated in which the vehicle is equipped with a discharging apparatus 16 for unloading the material from the containers while the containers remain supported on the flat deck.

Each container 10 typically comprises a base 20 arranged to be supported on a horizontal supporting surface such as the flat deck of the vehicles. A container body 22 is supported on the base 20 to define an enclosure which contains the bulk material therein. The body 22 is formed of a plurality of panels integrally joined with one another as a separate component from the base 20 but which is coupled in fixed relation to the base in operation.

The container body 22 comprises an upper portion 24 comprising a front side wall 26 at the front side of the container, a rear side wall 28 at the rear side of the container parallel and opposite to the front side wall, and a pair of intermediate side walls 30 spanning between the front and rear side walls of the container parallel and opposite to one another. The four side walls together form a perimeter which fully surrounds the hollow interior of the container body between a hopper portion 32 at a bottom end of the container and a top wall 34 at a top end of the container.

The side walls are substantially vertical in orientation between the hopper portion and the top ends thereof which are joined by the top wall 34 spanning the side walls at the top end of the container. Integral channels 36 are formed in the opposing intermediate side walls to extend vertically therealong for structural stiffening of the side walls.

The four side walls are integrally joined with one another at the four corners of the body. A lower portion of each corner includes a recessed mounting channel 37 formed therein which extends vertically upward from the hopper portion only partway along a height of the upper portion 24. Each recessed mounting channel 37 is recessed inwardly in relation to the two adjacent side walls of the respective corner of the container so as to receive a mating portion 39 of the base 20 therein when the container body is supported on the base as described in further detail below.

The top wall 34 tapers upwardly and inwardly from the four side walls to a central inlet opening 38 receiving a lid 40 thereon. An operating linkage 42 supports the lid 40 for movement relative to the top wall between a closed position in which the lid spans the inlet opening to enclose the top end of the container body and an open position in which the inlet opening 38 is substantially unobstructed by the lid 40.

The upper portion 24 of the container body joins the hopper portion 32 therebelow about a full perimeter of the top end of the hopper portion such that the side walls extend upwardly from the hopper portion about the perimeter of the container. The hopper portion tapers downwardly and inwardly from the upper perimeter thereof joined to the upper portion towards a gate opening 44 at the bottom end of the hopper portion for discharging material from the container therethrough. The hopper portion 32 comprises a rear bottom portion 46 comprising a flat panel joined to the upper perimeter of the hopper portion along the rear side of the container at a top edge thereof such that the panel extends downwardly and forwardly from the rear side to a bottom edge located at the front side in which the bottom edge of the rear bottom portion 46 defines the bottom edge of the gate opening extending upward therefrom. The rear bottom portion 46 thus spans substantially the full width of the container between the rear side and the front side thereof.

The hopper portion 32 further comprises a front portion 48 extending downwardly from the upper perimeter of the hopper portion at the front wall towards the front bottom edge of the rear bottom portion 46 to locate the gate opening therein in an upright plane which is substantially vertical at the front side of the container.

The hopper portion also comprises a pair of intermediate portions 50 extending downwardly and inwardly from opposing sides of the hopper portion corresponding to the intermediate sides 30 of the upper portion thereabove. The intermediate portions 50 span between the intermediate walls thereabove and the rear bottom portion 46 and front portion 48 therebelow such that the two intermediate portions are symmetrical with one another and are generally triangular. The intermediate portions are tapered downwardly and inwardly towards one another such that the front and rear portions of the hopper portion both become narrower in width from the top end to the bottom end thereof.

The base 20 of the container generally comprises an open frame comprising four vertical corner posts 51 at respective corners of the container. A pair of first crossbars 52A each span horizontally between respective front and rear corner posts along respective sides of the base. A front crossbar 52B is joined horizontally between the two first crossbars 52A adjacent the front posts and a rear crossbar 52C is joined horizontally between the two first crossbars 52A adjacent the rear corner posts for additional structural support.

A pair of channel members 53 are supported at laterally spaced apart positions mounted between the two first crossbars to extend in the longitudinal direction between the front and rear sides of the container. The channels each have a U-shaped cross-section which is inverted in orientation and has a suitable size to receive the lifting forks of a palette mover in the respective channels for handling the container.

The base 20 further comprises a plurality of support flanges mounted between respective ones of the posts 51 spaced upwardly from the crossbars to be joined between the posts adjacent the top end of the base in which the support flanges are arranged to support respective sides of the hopper portion thereon. In particular, a rear support flange 54A spans between the two rear posts and includes an inner surface which is inclined downwardly and forwardly similarly to the rear bottom portion 46 of the hopper portion supported thereon. A pair of side support flanges 54B span along opposing sides of the container between respective front and rear corner posts and include inner surfaces which are inclined downwardly and inwardly towards one another similarly to the inclination of the intermediate portions 50 of the hopper portion. A front support flange 54C is joined between the two front corner posts with an inner surface oriented for abutment against the front portion 48 of the container. The inward tapering of the support flanges automatically centers the container body in relation to the base.

The mating portions 39 of the base 20 are provided at each of the four corners of the base such that each mating portion 39 extends upwardly from a respective one of the four corner posts. Each mating portion 39 comprises a pair of vertical flanges at right angles to one another such that the two flanges overlap respective ones of the two adjacent sides of the upper portion of the container body within the respective recessed mounting channel 37 when the hopper portion is centered within the support flanges of the base. Suitable fasteners can be inserted through respective mounting apertures in the flanges of the mating portion 39 of the base to fasten the container body relative to the base 20.

A gate 56 is provided for sliding movement relative to the gate opening in the front portion 48 of the container body. The gate 56 is supported for sliding movement between a closed position spanning across the gate opening in an upright orientation parallel to the front portion of the hopper and the plane of the gate opening therein and an open position in which the gate 56 is displaced upwardly in relation to the closed position such that the gate opening is substantially unobstructed by the gate.

By locating the gate opening in an upright plane offset closer to the front side of the container than any of the other sides, the containers can be oriented on the flat deck of a truck or trailer so as to discharge the material from the container laterally to one side of the vehicle while the container remains supported on the vehicle without any costly modification to the vehicle being required.

The operation of the gate is controlled by a suitable operating linkage 57A which is manually operated and which is supported on a support member 57B spanning between the two front corner posts above the gate opening. The operating linkage in the illustrated embodiment comprises a rotatable handle member 57C which is connected to the gate 56 to lift and open the gate when rotated in one direction and to lower and close the gate when rotated in an opposing direction.

In a typical configuration, the flat deck 12 of the vehicle or trailer 14 is supported on respective wheels 58 for rolling movement on the ground in forward working direction. The deck is elongate in the forward working direction to define two longitudinally extending side edges 60 spaced apart along opposing sides by the width of the deck. The width typically comprises the width of two containers positioned side by side in the order of eight feet across. Various lengths of the deck are possible such that plural pairs of the containers 10 can be received on the deck sequentially along the length of the trailer.

Each pair of containers is typically positioned on the flat deck such that the rear sides of the containers are abutted against one another with the front sides of the containers facing laterally outwardly in opposing directions adjacent respective opposing longitudinally extending side edges 60 such that the gate openings of all of the containers are located directly adjacent one of the respective side edges of the deck. Any one of the containers can thus be independently discharged laterally outward to one side of the flat deck independently of the other containers.

The discharge apparatus 16 is supported on the deck to facilitate unloading of the bulk material from the containers while the containers remain supported on the flat deck. The discharge apparatus 16 may be formed integrally with the flat deck or may be added on as a kit which is retrofit onto existing commercially available flat deck trucks and trailers.

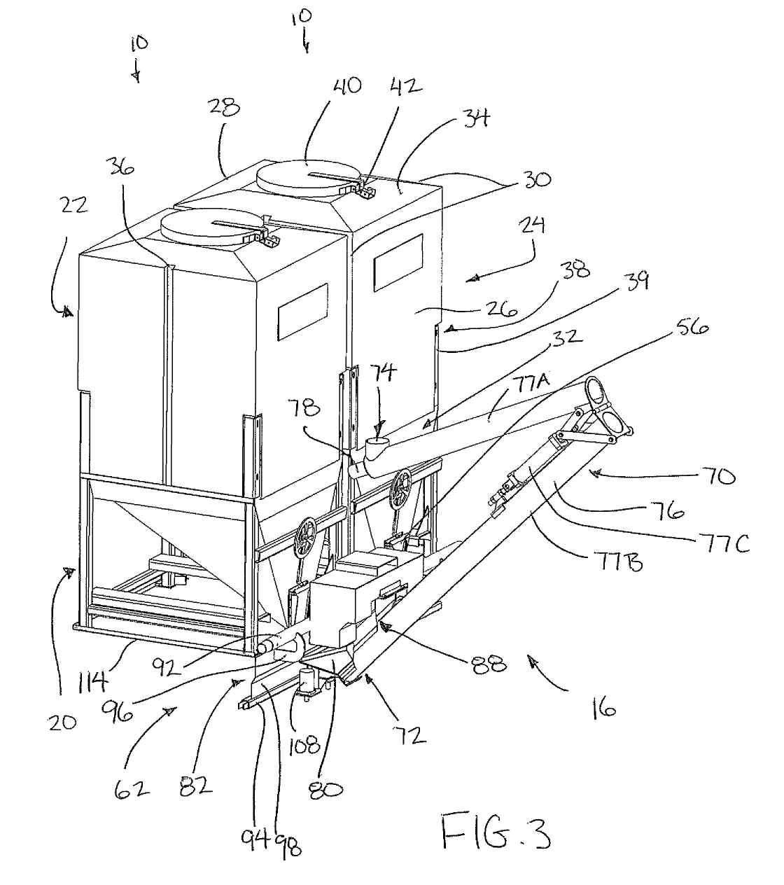

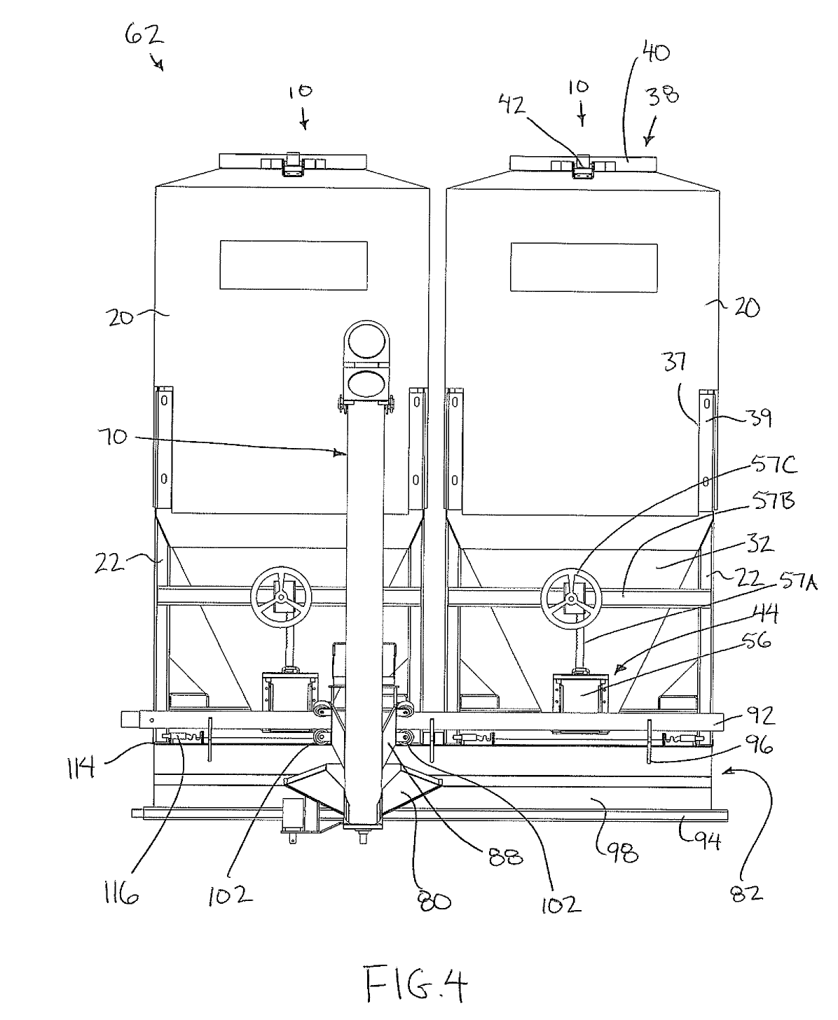

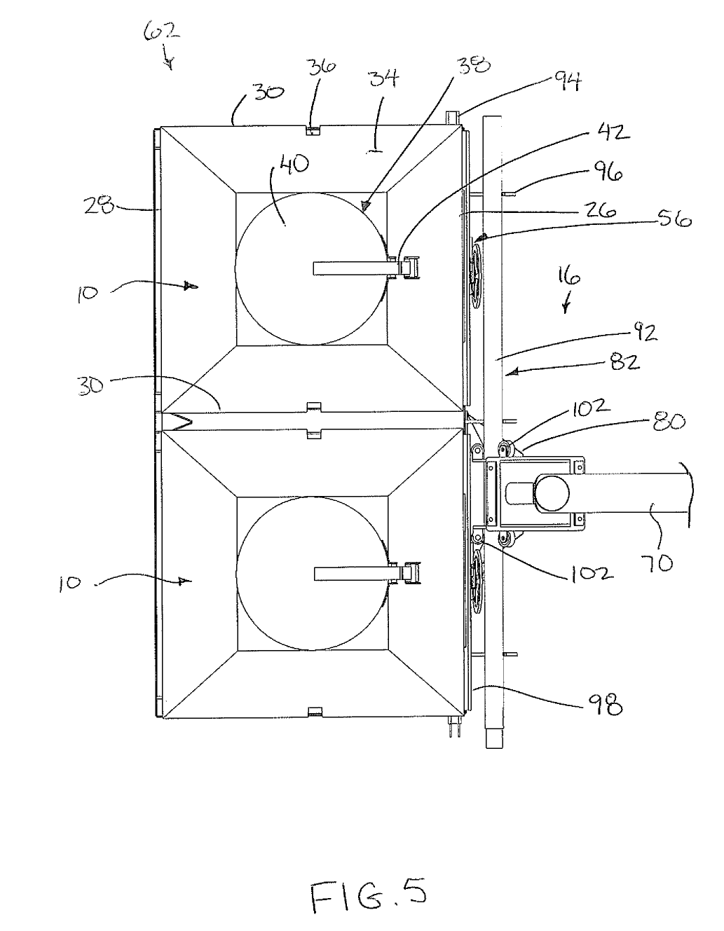

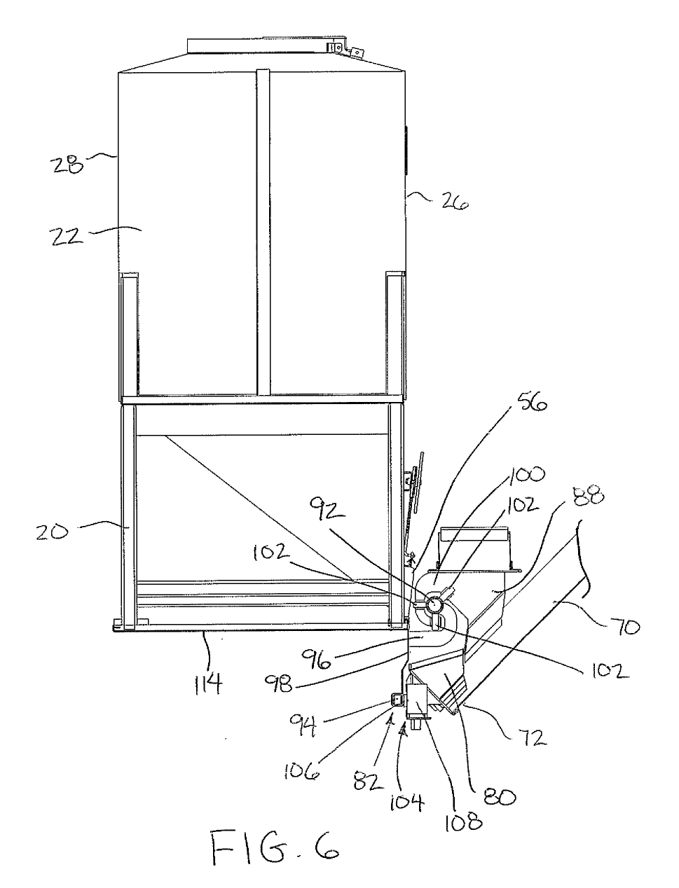

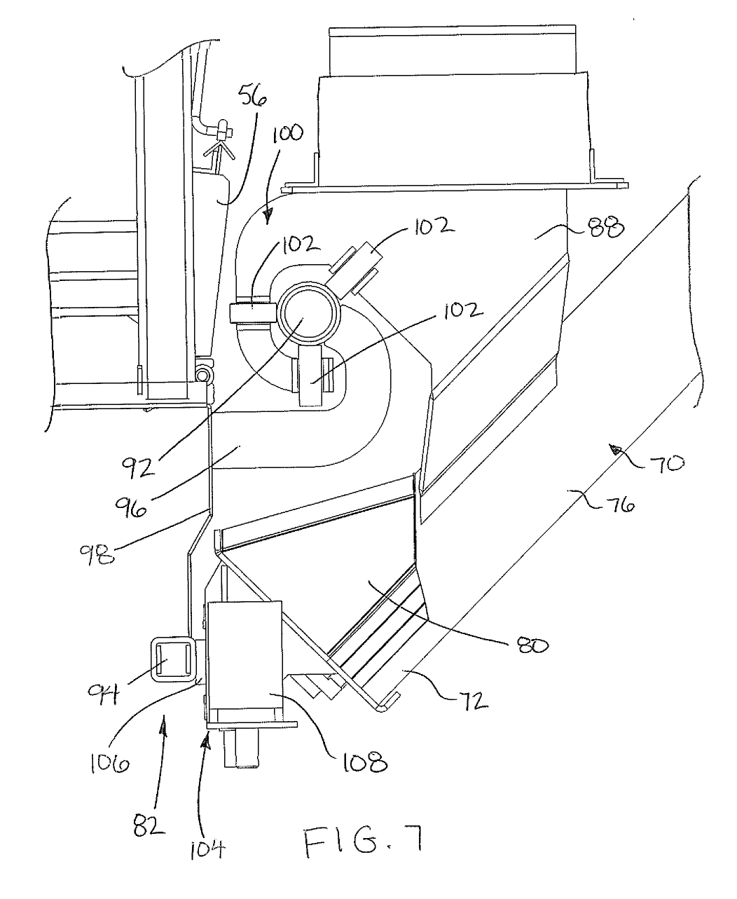

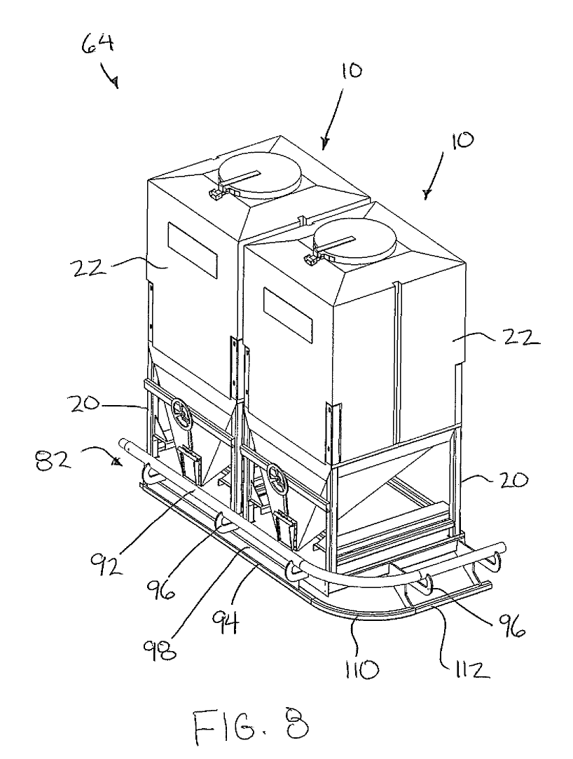

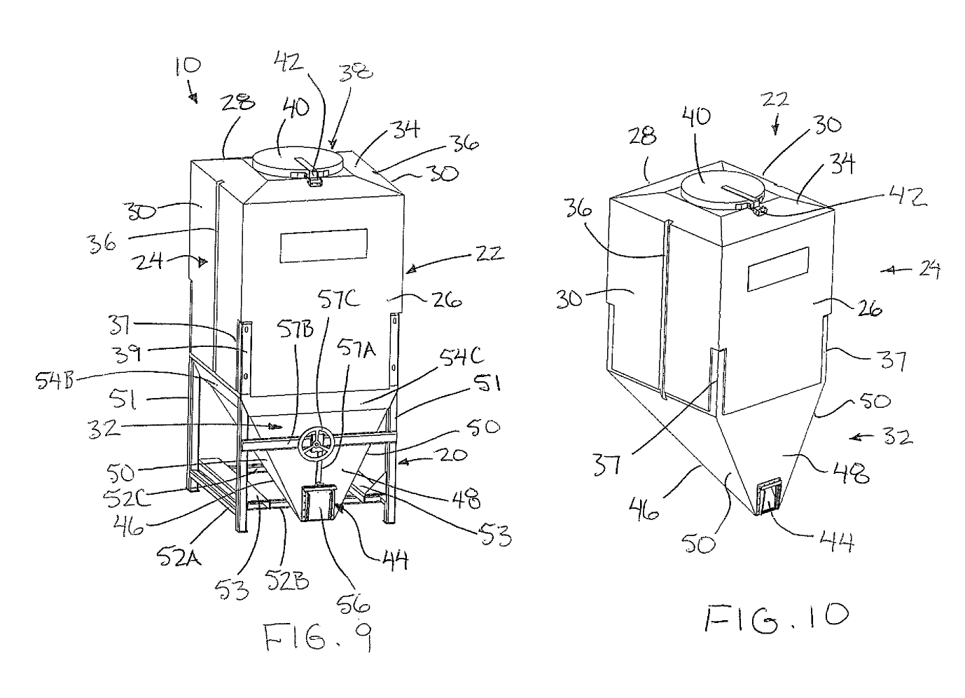

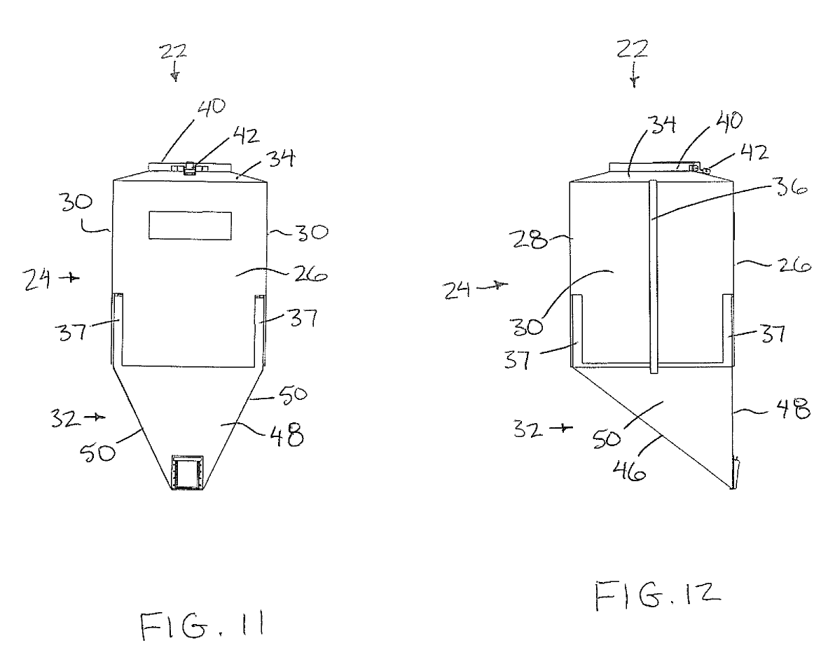

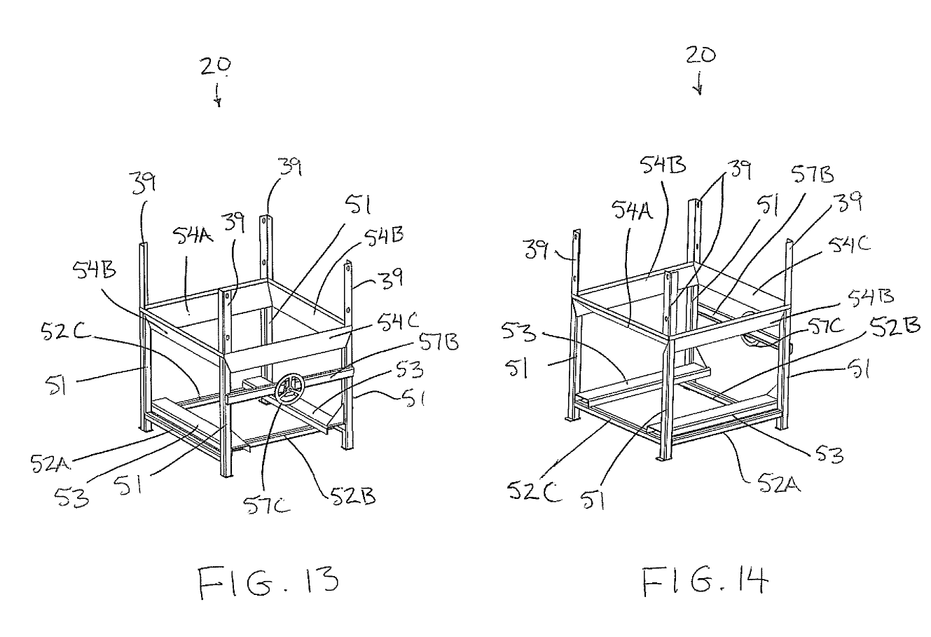

When added on to an existing flat deck, the apparatus 16 is typically assembled from a plurality of modular sections. Each modular section is typically suited for spanning a length of two containers in the longitudinal direction of the vehicle. A plurality of first modular sections 62, as shown in FIGS. 3 through 7, are suited for mounting in series within one another at intermediate locations along the sides of the flat deck. Alternatively, a plurality of second modular sections 64, as shown in FIG. 8, are suited for mounting at the corners of the flat deck. The differences in configuration of the first and second modular sections will be described further below.

The discharge apparatus 16 comprises a discharge conveyor 70 arranged to convey the particulate material from an inlet end 72 to an outlet end 74 of the conveyor. More particularly the conveyor 70 comprises a conveyor tube 76 which defines a hollow passage from an inlet opening at the inlet end 72 to an outlet opening at the outlet end 74. A conveyor auger is rotatably supported within the conveyor tube and is driven to rotate relative to the tube by a suitable auger motor 78 supported externally on the conveyor tube.

The conveyor tube 76 of the discharge conveyor 70 comprises an inner section 77A and an outer section 77B which are pivotal relative to one another between a working position in which the inner and outer sections are connected in line and in series which one another and a transport position in which the outer section is folded relative to the inner section. More particularly, the outer section is pivoted about a horizontal axis such that the outer section is displaced inwardly towards the inner end of the conveyor tube adjacent the flat deck in the transport position. A hydraulic actuator 77C is coupled by a linkage to operate between the inner and outer sections for controllably displacing the outer section between the working and transport positions.

The discharge apparatus 16 further comprises an inlet hopper 80 supported on the inlet end of the discharge conveyor. The hopper is mounted in fixed relation to the conveyor tube. An open top end of the hopper receives bulk material therein from the bulk material containers. A plane of the opening at the top end of the hopper is inclined downwardly and inwardly towards the flat deck for optimal alignment with material discharged from the gates of the respective containers on the deck.

The inlet hopper 80 comprises opposing side walls and an end wall which are tapered downwardly and inwardly towards a center of the hopper from the open top end to a bottom end in communication with the inlet opening at the inlet end of the conveyor tube. The inlet hopper 80 and the open top end thereof are suitably sized for alignment with a selected one of the bulk material containers to receive all of the material from the gate opening thereof when the gate is opened.

A track 82 supports the conveyor 70 and the inlet hopper 80 thereof for movement together relative to the flat deck generally in the longitudinal forward working direction of the deck to selectively align the inlet hopper and the discharge conveyor with different selected ones of the bulk material containers.

The fully assembled track 82 generally comprises two primary straight sections 84 which extend along the opposing side edges of the deck respectively so as to be parallel to one another and spaced apart on opposing sides of the deck. The assembled track 82 also includes a secondary end section 86 which is joined between the primary straight sections at one end of the deck such that the two primary sections and the secondary section form a continuous generally U-shaped track about the deck.

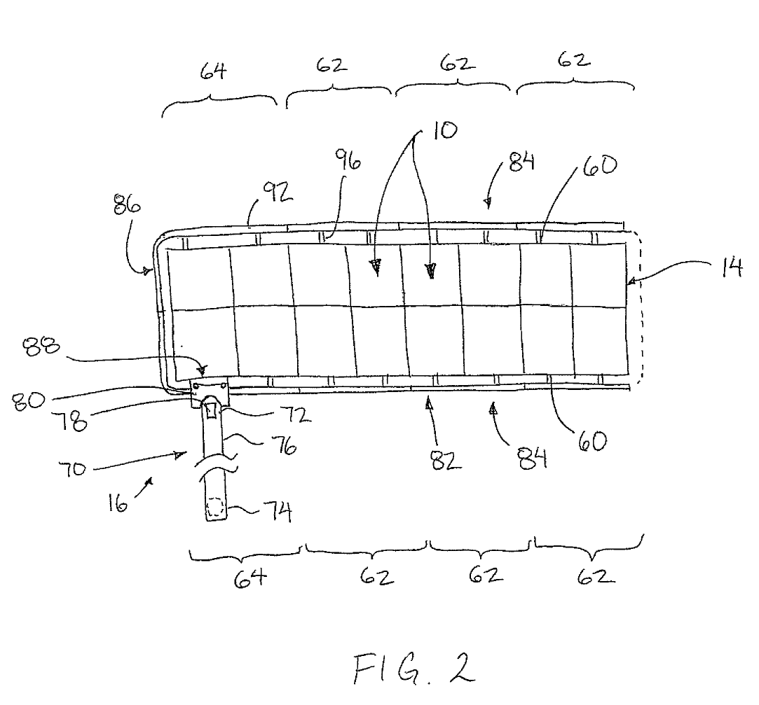

In the illustrated embodiment the secondary section extends about a rear end of the deck, however in further embodiments the secondary section 86 can readily be connected between the two primary sections in a similar manner at the forward end of the deck as shown in broken line FIG. 2.

A carriage body 88 is provided for supporting the conveyor and inlet hopper slidably along the track on rollers which are in rolling engagement with the track for displacing the conveyor along both of the primary sections as well as between the two primary sections along the secondary section across the end of the flat deck.

The full length of the track comprises an upper rail 92 and a lower rail 94 which are parallel and spaced one above the other. The upper rail generally comprises a rod or tube of circular cross section which is formed of rigid metal over top of which an upper portion of the carriage body 88 is hooked. The upper rail is supported at a height of the surface of the deck spaced laterally outward therefrom by a sufficient space between the edge of the deck and the rail that the material discharged from the containers can be received threrebetween as it is dispensed into the inlet hopper of the discharge conveyor.

A plurality of upper rail mounts 96 are mounted at spaced apart positions in the longitudinal direction along each of the primary sections of the upper rail in which the mounts 96 comprise vertical plates which are vertically oriented and span laterally outward from the side edge of the deck to the rail. The plates are generally U-shaped so that each upper rail mount 96 extends laterally outward from the side edge of deck below the surface thereof along a first portion, upwardly from the first portion at an outer end thereof and inwardly therefrom to connect to an outer side of the upper rail. The upper rail mounts 96 are secured to the side edges of the deck by suitable threaded fasteners and the like such that the brackets and the upper rail together remain readily removable from the deck. This is desirable to reduce the overall width of the deck of the road transport vehicle to accommodate regulations regarding a maximum width of the vehicle for use on roads.

The lower rail 94 of each section of the track comprises an elongate tubular beam typically having a square cross section as shown in the illustrated embodiment such that an outer side of the beam is generally flat and in a vertical orientation at a location spaced below the side edge of the deck so as to be substantially flush therewith and not protrude laterally outwardly beyond the edge of the deck. A depending wall member 98 spans vertically downwardly from the bottom side of the deck to the lower rail 94 supported spaced below the deck so that material discharged from the bins is prevented from being deflected inwardly below the deck.

As noted above, the carriage 88 comprises an upper portion 100 which forms a hook extending upwardly and over the upper rail including a retaining portion extending downwardly along the inner side of the rail to retain the carriage thereon. Two sets of rollers 102 are mounted rotatably on the upper portion of the carriage in the retaining portion for rolling engagement along the upper rail 92 at longitudinally spaced positions thereon when the carriage is supported on one of the primary sections of the track. Each set of rollers 102 comprises three rollers at circumferentially spaced positions about the upper rail such that a first roller rolls along an inner side of the rail, a second roller rolls along a bottom side of the rail, and a third roller rolls along an upper side of the rail at a location offset towards the outer side of the rail at a location diametrically opposite from the a central location between the first and second rollers. The rail mounts are connected to the outer side of the upper rail between the first and third rollers of each set.

In addition to the upper portion 100 above the inlet hopper, the carriage further comprises a lower portion 104 below the inlet hopper which is arranged to be slidably displaced alongside the lower rail 94. Another roller 106 is rotatably supported on the lower portion of the carriage for rolling engagement along the outer side of the lower rail 94 as the carriage and conveyor supported thereon are slidably displaced in the longitudinal direction along either one of the primary sections. The roller 106 is centered in the longitudinal direction of the flat deck and rails relative to the carriage and conveyor supported thereon.

A drive motor 108 is supported on the carriage body for movement therewith along the track. The drive motor 108 drives rotation of the roller 106 on the lower portion of the carriage in engagement with the lower rail to drive movement of the carriage along the track in the longitudinal direction thereof.

Along each section of the track, the carriage supports the conveyor in an operating position in which the conveyor extends generally upwardly and outward at an upward incline from the inlet end to the outlet end within a plane which is oriented generally perpendicularly to the longitudinal direction of the track.

As described above, the rails of the track of the discharge apparatus 16 is typically assembled from a plurality of first modular sections 62 as shown in FIG. 3 and a plurality of second modular sections 64 shown in FIG. 8. Each modular section of the apparatus 16 spans a length corresponding to a dimension of two bulk material containers in series with one another in the longitudinal working direction of the vehicle. Accordingly, each first modular section 62 comprises an appropriate straight length of the upper rail, the lower rail and the depending wall member extending downward from the deck to the lower rail. One end of each rail of the section includes a male connector while the other end defines a hollow female connector arranged to mate with the male connector of the next adjacent section.

Each second modular section 64 includes a straight length of the upper rail, the lower rail and the depending wall member as described above, along with an additional curved section 110 of the upper and lower rails which extends around a corner of the deck to an end section 112 which is horizontal and perpendicular to the straight section which extends in the longitudinal direction. The end section 112 has a length corresponding to half the width of the deck in the lateral direction such that placement of two second modular sections 64 which are symmetrical to one another at adjacent corners of the deck results in the track along opposing sides of the deck being connected to form a continuous U-shaped track about the deck as described above. The upper rail mounts 96 at the ends of the second modular sections 64 are similarly arranged relative to the upper rail as described above, but also include a lower portion supporting the lower rail.

Each modular section further comprises frame members 114 arranged to be fastened to the upper surface of the deck arranged to position the associated containers 10 relative to the respective modular section of the deck. The frame members 114 further comprise a latching mechanism 116 arranged to selectively latch the containers 10 to the frame members on the deck to fix the containers to the vehicle for transport.

The carriage can also be provided with a brake mechanism which serves to selectively fix the carriage relative to the track at any one of numerous positions therealong.

In use, the carriage is displaced along the track such that the inlet hopper thereon is aligned with a single selected on of the containers at which point the carriage is locked in position by braking the carriage in relation to the track at the selected position. Opening the gate of the selected container thus permits the bulk particulate material within the container to fall between the side edge of the deck and upper rail to be received into the open top end of the inlet hopper. Operation of the auger within the conveyor tube thus serves to convey the particulate material from the inlet end to the outlet end of the conveyor where it is discharged. When unloading of material from the selected container is complete, the drive motor is used to displace the carriage and the inlet hopper and conveyor supported thereon to be aligned with another selected container. When the desired containers have been unloaded, the carriage is displaced to a central position at one end of the flat deck and the conveyor tube is folded into the transport position.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A bulk material container for transporting particulate material therein, the container comprising:
a base arranged to be supported on a generally horizontal supporting surface;
a hopper portion supported on the base, the hopper portion tapering downwardly and inwardly from a perimeter about a top end of the hopper portion to a gate opening adjacent a bottom end of the hopper portion;
a plurality of side walls extending upwardly from the top end of the hopper portion fully about the perimeter of the hopper portion;
a top wall spanning between the side walls adjacent a top end of the side walls; and
a gate supported for movement between a closed position spanning the gate opening and an open position in which the gate opening is at least partially unobstructed by the gate;
wherein the gate opening is offset towards one side of the base so as to be nearer to one of the side walls.

2. The container according to claim 1 wherein the gate opening is located substantially in vertical alignment below one of the side walls.

3. The container according to claim 1 wherein the gate opening is oriented in an upright plane.

4. The container according to claim 1 wherein the base is rectangular comprising four sides, the gate opening being located adjacent one of the sides of the base.

5. The container according to claim 1 wherein the gate is slidable in an upright orientation between the closed position and the open position.

6. The container according to claim 1 wherein the plurality of side walls comprise a front wall at a front side of the container, a rear wall opposite the front wall at a rear side of the container and a pair of intermediate walls spanning between the front wall and the rear wall at opposing sides; wherein the gate opening is located in the front side of the container; and wherein the hopper portion tapers downwardly and forwardly towards the gate opening at the front side.

7. The container according to claim 6 wherein the hopper portion comprises a bottom portion tapering downwardly and forwardly from the rear side of the container to the gate opening at the front side of the container.

8. The container according to claim 6 wherein the hopper portion comprises a front portion extending downwardly from the front wall and locating the gate opening therein.

9. The container according to claim 1 in combination with a road transport vehicle comprising a flat deck having side edges extending in a longitudinal working direction of rolling movement of the vehicle and a plurality of other bulk material containers of like configuration supported on the flat deck, wherein the gate openings are offset towards a first side of the respective containers and wherein the bulk material containers are supported adjacent to one another in pairs such that the first sides of each pair of containers are situated at respective ones of the side edges of the flat deck.

10. A discharging apparatus in combination with a road transport vehicle and a plurality of bulk material containers according to claim 1, the road transport vehicle comprising a flat deck having side edges extending in a longitudinal working direction of rolling movement of the vehicle and supporting the plurality of bulk material containers thereon such that the gate openings are arranged to discharge bulk material towards the sides edges of the flat deck, and the discharge apparatus comprising:
a discharge conveyor arranged to convey bulk material from an inlet end to an outlet end thereof;
a track arranged to support the discharge conveyor on the vehicle for sliding movement relative to the vehicle in the longitudinal working direction of the vehicle; and
an inlet hopper supported on the discharge conveyor in communication with the inlet end of the discharge conveyor and including an open top end arranged to receive bulk material from the bulk material containers therein;
the inlet hopper being slidable together with the discharge conveyor along the track such that the inlet hopper is arranged to be aligned with different ones of the bulk material containers as the discharge conveyor is displaced in the longitudinal working direction of the vehicle.

11. The apparatus according to claim 10 further comprising a carriage comprising rollers supported for rolling movement along the track, the discharge conveyor and the inlet hopper being supported on the carriage so as to extend upwardly and outwardly away from the track from the inlet end to the outlet end of the discharge conveyor.

12. The apparatus according to claim 10 further comprising:
a carriage comprising rollers supported for rolling movement along the track, the carriage supporting the discharge conveyor and the inlet hopper thereon for movement along the track;
a drive motor supported on the carriage; and
a drive wheel rotatably supported on the carriage so as to be arranged to engage the track, the drive wheel being driven to rotate by the drive motor so as to be arranged to displace the carriage along the track.

13. The apparatus according to claim 10 wherein the track comprises a pair of rails extending parallel and spaced apart one above the other to extend in the longitudinal working direction and wherein there is provided a carriage supporting the discharge conveyor and the inlet hopper thereon for movement along the pair of rails.

14. The apparatus according to claim 13 wherein one of the rails is arranged to be supported substantially at a height of a surface of the deck, spaced outwardly from the side edge of the deck and the other one of the rails is arranged to be supported below the deck.

15. The apparatus according to claim 10 wherein there is provided a plurality of track mounts arranged to support the track on the deck such that the track is readily separable from the deck of the vehicle.

16. The apparatus according to claim 10 wherein the track comprises a pair of primary sections arranged to be supported along the side edges of the deck and a secondary section connected between the pair of primary sections at one end of the deck, the discharge conveyor being movable along the track from one primary section to the other primary section across the secondary section of the track.

17. The apparatus according to claim 10 wherein the road transport vehicle comprises a flat deck trailer.

18. The apparatus according to claim 10 wherein the discharge conveyor comprises an inner section and an outer section which are pivotal relative to one another between a working position in which the inner and outer sections are connected in series which one another and a transport position in which the outer section is folded relative to the inner section.

19. The apparatus according to claim 10 wherein the track is assembled from modular sections, each modular section spanning a length corresponding to a dimension of a plurality of bulk material containers in series with one another in the longitudinal working direction of the vehicle.

20. A discharging apparatus arranged for use with a road transport vehicle comprising a flat deck having side edges extending in a longitudinal working direction of rolling movement of the vehicle and a plurality of bulk material containers having respective hopper portions tapering downwardly and inwardly to respective gate openings and being supported on the flat deck such that the gate openings are arranged to discharge bulk material towards the sides edges of the flat deck, the discharge apparatus comprising:
a discharge conveyor arranged to convey bulk material from an inlet end to an outlet end thereof;
a track arranged to support the discharge conveyor on the vehicle for sliding movement relative to the vehicle in the longitudinal working direction of the vehicle; and
an inlet hopper supported on the discharge conveyor in communication with the inlet end of the discharge conveyor and including an open top end arranged to receive bulk material from the bulk material containers therein;
the inlet hopper being slidable together with the discharge conveyor along the track such that the inlet hopper is arranged to be aligned with different ones of the bulk material containers as the discharge conveyor is displaced in the longitudinal working direction of the vehicle.
